(19) United States
(12) Patent Application Publication
(10) Pub. No.: US 2017/0091825 A1
(43) Pub. Date: Mar. 30, 2017

(54) FASHION PROFILE MECHANISM

(71) Applicant: Vadim Gore, Beaverton, OR (US)

(72) Inventor: Vadim Gore, Beaverton, OR (US)

(21) Appl. No.: 14/866,183

(22) Filed: Sep. 25, 2015

(51) Int. Cl. G06Q 30/02

(52) U.S. Cl. CPC G06Q 30/0271; G06Q 30/0277

(57) ABSTRACT

A fashion profile platform is described. The fashion profile platform includes an analytics platform to receive consumer data from one or more consumer computing devices, generate a fashion profile for each of the one or more consumer devices based on the consumer data and provide analysis of the fashion profiles to one or more retail computing devices.

### FIELD

Embodiments described herein generally relate to wearable computing. More particularly, embodiments relate to data services provided for wearable devices.

### BACKGROUND

It is often realized that consumer shopping is a task that requires an abundance of time. Shoppers once relied on a familiar salesperson, such as an owner of a local general store, to assist in finding desired items for purchase. Drawing on knowledge of a customer enabled the salesperson to quickly locate a suitable product, as well as suggest additional items the customer hadn't thought of purchasing. A new generation of consumers lead busy lives and have become accustomed to expect a personalized experience while, socializing and watching content online. However, having a personal human stylist for every shopper is very expensive and impracticable.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates one embodiment of a computing device.

FIG. 2 illustrates one embodiment of a personalized shopping network.

FIG. 3 illustrates one embodiment of computing devices.

FIG. 4 illustrates one embodiment of consumer fashion profile generation.

FIG. 5 illustrates one embodiment of hierarchical relationships between fashion profile platform data types.

FIG. 6 is a flow diagram illustrating one embodiment of interactions within a personalized shopping network.

FIG. 7 illustrates a computer system suitable for implementing embodiments of the present disclosure.

### DETAILED DESCRIPTION

Embodiments may be embodied in systems, apparatuses, and methods for a fashion profile platform, as described below. In the description, numerous specific details, such as component and system configurations, may be set forth in order to provide a more thorough understanding of the present invention. In other instances, well-known structures, circuits, and the like have not been shown in detail, to avoid unnecessarily obscuring the present invention.

Embodiments provide for an identity-based fashion profile data platform that enables fashion-minded consumers at computing devices to control and centrally manage fashion aspirations and style preferences. In such an embodiment, a comprehensive fashion profile is generated over time for individual consumers by combining multiple lifestyle and fashion applications developed by fashion brand partners through Fashion IQ APIs. In a further embodiment, the profile data platform provides analytics capability to merge multiple data sources and generate actionable recommendations for consumers (e.g., smart wardrobe recommendations) and retailers (e.g., personalized customer service for the most valuable customers).

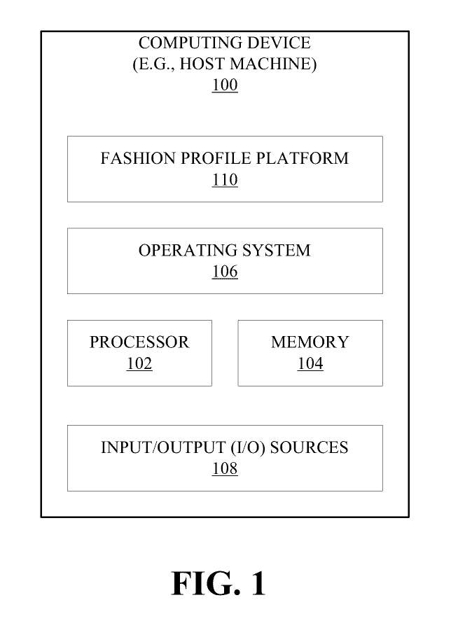

FIG. 1 illustrates one embodiment of a computing device 100 implementing a fashion profile platform component 110. In one embodiment, computing device 100 serves as a host machine for hosting fashion profile platform 110 that includes a combination of any number and type of components for implementing personalized shopping at computing devices, such as computing device 100. In one embodiment, computing device 100 includes a host computing machine implemented at one or more server computers.

In other embodiments, fashion profile platform operations may be performed at a computing device 100 including large computing systems, mobile computing devices, such as cellular phones including smartphones, personal digital assistants (PDAs), tablet computers, laptop computers (e.g., notebook, netbook, Ultrabook™, etc.), e-readers, etc. In yet other embodiments, computing device 100 may include desktop computers, etc., and may further include set-top boxes (e.g., Internet-based cable television set-top boxes, etc.), global positioning system (GPS)-based devices, etc.

Computing device 100 may include an operating system (OS) 106 serving as an interface between hardware and/or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc.

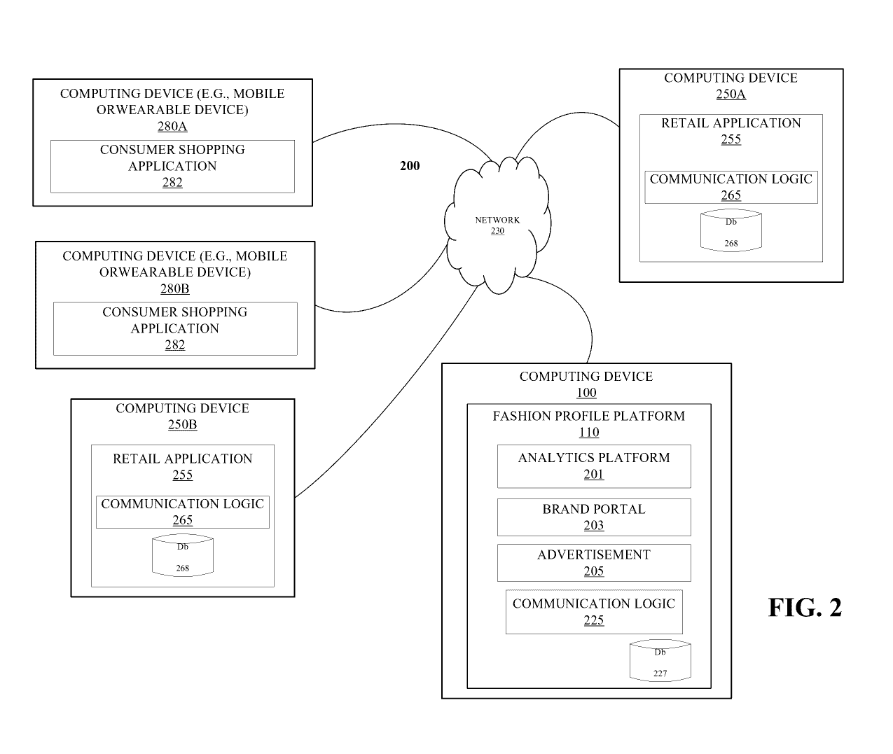

FIG. 2 illustrates one embodiment of a personalized shopping network 200. Personalized shopping network 200 includes computing device 100 having fashion profile platform 110, one or more computing devices 250 (e.g., 250A and 250B) having a retail application component 255, and one or more computing device 280 (e.g., 280A and 280B) implementing a consumer application 282. Throughout this document, terms like “logic”, “component”, “module”, “framework”, “engine”, “point”, and the like, may be referenced interchangeably and include, by way of example, software, hardware, and/or any combination of software and hardware, such as firmware.

It is contemplated that any number and type of components may be added to and/or removed from personalized shopping network 200 to facilitate various embodiments including adding, removing, and/or enhancing certain features. For brevity, clarity, and ease of understanding of personalized shopping network 200, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

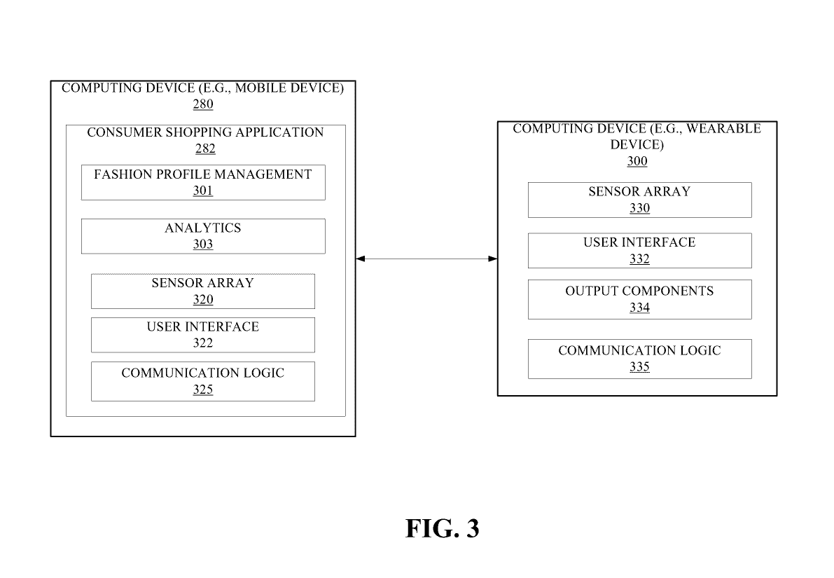

Consumer shopping application 282 at computing device 280 enables a consumer to generate and manage a fashion profile. FIG. 3 illustrates a more detailed embodiment of computing devices 280. Consumer shopping application 282 includes fashion profile management module 301 and analytics module 303. Fashion profile management module 301 manages a consumer's fashion profile. In one embodiment, a fashion profile includes basic consumer demographic information, fashion aspirations and style preferences. In a further embodiment, consumer shopping application 282 converts the fashion profile into fashion analytics maintained at analytics module 303 and uploads to fashion profile platform 110 at computing device 100.

Computing device 100 also includes a sensor array 320, which may include an image capturing device, such as a camera, implemented by shopping application 282. In a further embodiment, sensor array 320 may include other types of sensing components, such as context-aware sensors (e.g., myoelectric sensors, temperature sensors, facial expression and feature measurement sensors working with one or more cameras, environment sensors (such as to sense background colors, lights, etc.), biometric sensors (such as to detect fingerprints, facial points or features, etc.), and the like.

User interface 322 provides for user interaction with computing device 282. In one embodiment, user interface 222 enables a consumer to interact with consumer shopping application 282. Communication logic 325 may be used to facilitate dynamic communication and compatibility between various computing devices, such as computing device 282 and computing devices 100 and 250, storage devices, databases and/or data sources, networks, such as network 230 (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), connectivity and location management techniques, software applications/websites, programming languages, etc., while ensuring compatibility with changing technologies, parameters, protocols, standards, etc.

According to one embodiment, communication logic 225 may also communicate with communication logic 235 of a wearable computing device 300 via Bluetooth low energy (BLE). In such an embodiment, computing device 300 includes a sensor array 330 (e.g., LED sensor and audio microphone), user interface 332 and output components 334 (e.g., display and vibrator). In some embodiments, consumer application 282 may be solely implemented in wearable device 300.

Referring back to FIG. 2, computing devices 250 may also include communication logic 265, which may be similar to or the same as communication logic 325 of computing device 280 and may be used to facilitate communication with computing device 100 and/or communication devices 280 via network 230. Retail application 255 manages customer relationship data for consumers implementing consumer shopping application 282. In such an embodiment, database 268 maintains and organizes such customer data.

Computing device 100 also includes communication logic 225 to interface with computing devices 250 and 280. Communication logic 225 of computing devices 100 may be similar to or the same as communication logic 325 of computing device 280, and may be used to facilitate communication with platform 110 via network 230. Further, logic 225, 325 and 285 may be arranged or configured to use any one or more of communication technologies, such as wireless or wired communications and relevant protocols (e.g., Wi-Fi®, WiMAX, Ethernet, etc.), to facilitate communication over one or more networks, such as network 230 (e.g., Internet, intranet, cloud network, proximity network (e.g., Bluetooth, etc.).

In one embodiment, fashion profile platform 110 provides fashion analytics data for consumers using applications 282. Fashion profile platform 110 may include any number and type of components, such as: analytics platform 201, brand portal 208, advertisement module 205, and database 227. According to one embodiment, analytics platform 201 provides retailers with real-time analysis as to consumers' shopping experience, based on data received from consumer shopping applications 282. Thus, fashion profile platform 110 provides personalized consumer facing insight based on consumer analytics and aggregated anonymized business intelligence insight based on retail analytics.

An example of consumer based analytics is a geographic location alert that appears on a consumer's wearable device as the consumer enters a store. The alert may include specific product recommendation tailored to the consumer's style preferences and budget as per the consumer's fashion profile stored at fashion profile platform 110.

In a further embodiment, analytics platform 201 enables identification of customer service issues and actions to correct such issues. In yet a further embodiment, analytics platform 201 generates a predictive intelligence system to improve future consumer experiences. Examples of retail analytics enabled by this invention include pro-active monitoring of how stores and individual associates rate in customer service (e.g., per brand and location); optimization of associates' time management and availability; measurement of consumers' actions on the associate's recommendations, provision of product recommendation based on previous purchases, customer's fashion profile, retailer product marketing campaigns and purchases of consumers with similar fashion tastes; customization of in-store digital signage to consumer's fashion aspirations; and determining a retail store's foot traffic based on the aggregated interactions between shoppers wearable devices and in-store beacons.

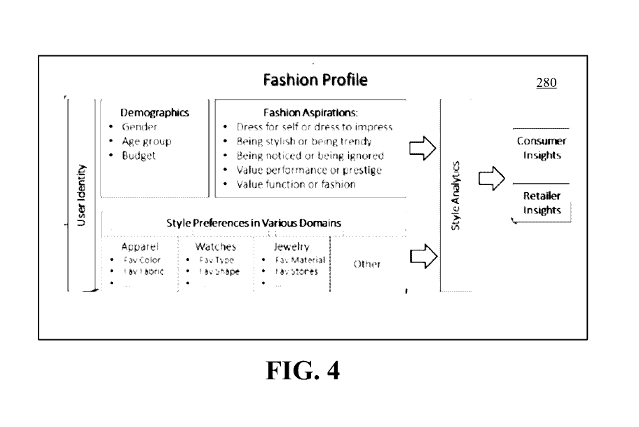

FIG. 4 illustrates one embodiment of a consumer fashion profile generation at fashion profile platform 110. As shown in FIG. 4, fashion profile platform 110 associates demographic, fashion aspiration and style preference data with a user identity in order to generate style analytics for a consumer. Based on the style analytics, insight may be provided to both the consumer and one or more retailers. According to one embodiment, analytics module 201 implements a hierarchical structure of data-types that represent various pieces of fashion profile data: from user aspirations, through style preferences to specific product description. In such an embodiment, each data type includes a name and a list of attributes.

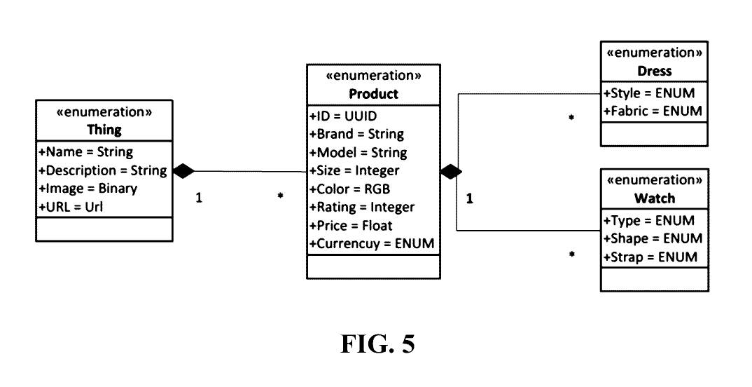

FIG. 5 illustrates one embodiment of hierarchical relationships between fashion profile platform data types. At the root of all data types is the most generic data-type called “Thing”, which includes the following attributes: “name”, “description”, “image” and “url”. Other more specific data-types inherit generic attributes from their parent data types. For example, a data-type “Product” inherits generic attributes from Thing and adds the following new attributes: “id”, “brand”, “model”, “size”, “color”, “rating” and “pricerange”. The data-type “Watch” inherits from Product and add “type”, “shape” and “strap” as its own attributes. In a further embodiment, fashion profile platform 110 may create an instance of a known data type, or define custom data-types under its own namespace. Such data types establish schema through which various applications understand one another's domain data.

Referring back to FIG. 2, brand portal 202 provides a portal that presents an analytics dashboard to each computing device 250 via the respective retail application 255 in to provide real time retail updates (e.g., how the retailer's stores and individual associates are rated on customer service). Advertisement module 205 enables the creation of targeted advertisement campaigns personalized in accordance with a customer's fashion profile. Additionally, advertisement module 205 delivers personal advertising (e.g., from private ad network software) to an application 282 at a mobile, or wearable, device 280, and measures accurate click-through rate and purchase intent. Database 227 stores data for advertisement module 283 and analytics platform 284, as well as fashion profile data. In one embodiment, the profile data includes curated fashion data from a variety of sources (e.g., fashion/lifestyle applications or brand partner CRM)

During operation of analytics platform 201, information from retail application 255 and consumer application 282 flow into analytics platform 201. Subsequently, the data is augmented with relevant information from a consumer's fashion profile and third party information, such as social networks and retail customer relationship management (CRM). Retailer product and campaign rules then flow into advertisement module 205. Analytics platform 201 subsequently performs data analysis and generates actionable insight (e.g., for consumers, concierges and brand/retail analysts). Finally, the information is disseminated to the interested parties in a form of product recommendations, customer service alerts, etc.

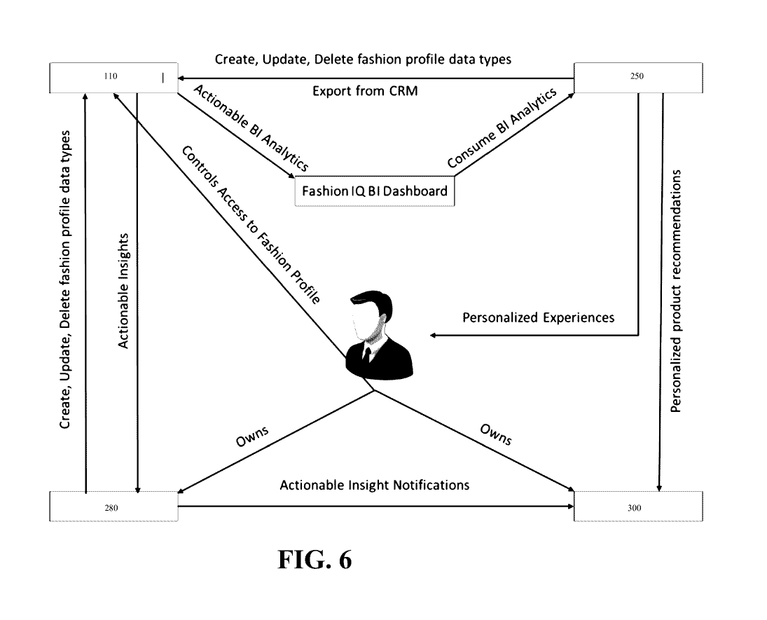

FIG. 6 is a flow diagram illustrating one embodiment of a process performed within personalized shopping network 200. The process may be performed by processing logic that may comprise hardware (e.g., circuitry, dedicated logic, programmable logic, etc.), software (such as instructions run on a processing device), or a combination thereof. The processes are illustrated in linear sequences for brevity and clarity in presentation; however, it is contemplated that any number of them can be performed in parallel, asynchronously, or in different orders.

To begin use of fashion profile platform 110, a consumer at a consumer shopping application 282, operating on a device 280, creates, updates or deletes fashion profile data types. In one embodiment, the consumer controls access to his/her profile at shopping application 282. Independently, a retailer at retail application 255, operating on device 250, also creates, updates or deletes fashion profile data types. Subsequently, actionable insight may be received at shopping application 282 from fashion profile platform 110, resulting in a consumer notification being displayed at wearable computing device 300.

Additionally, fashion profile platform 110 generates business intelligence analytics data that is posted on a dashboard associated with the retailer. The retailer may subsequently access the dashboard from application 255 at device 250 in order to access the business intelligence analytics data. Based on the analytics data, application 255 may transmit personalized product recommendations and/or targeted advertising for display at computing device 300. In a further embodiment, computing device 300 may receive a BLE signal upon entering a retail store associated with retail application 255.

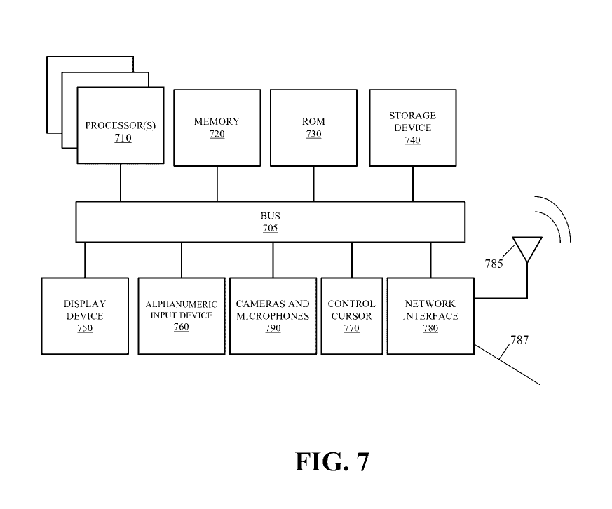

FIG. 7 illustrates a computer system suitable for implementing embodiments of the present disclosure. Computing system 700 includes bus 705 (or, for example, a link, an interconnect, or another type of communication device or interface to communicate information) and processor 710 coupled to bus 705 that may process information. While computing system 700 is illustrated with a single processor, electronic system 700 and may include multiple processors and/or co-processors, such as one or more of central processors, graphics processors, and physics processors, etc. Computing system 700 may further include random access memory (RAM) or other dynamic storage device 520 (referred to as main memory), coupled to bus 705 and may store information and instructions that may be executed by processor 710. Main memory 720 may also be used to store temporary variables or other intermediate information during execution of instructions by processor 710.

Computing system 700 may also include read only memory (ROM) and/or other storage device 530 coupled to bus 705 that may store static information and instructions for processor 510. Date storage device 740 may be coupled to bus 705 to store information and instructions. Date storage device 740, such as magnetic disk or optical disc and corresponding drive may be coupled to computing system 700.

Computing system 700 may also be coupled via bus 705 to display device 750, such as a cathode ray tube (CRT), liquid crystal display (LCD) or Organic Light Emitting Diode (OLED) array, to display information to a user. User input device 760, including alphanumeric and other keys, may be coupled to bus 705 to communicate information and command selections to processor 710. Another type of user input device 760 is cursor control 770, such as a mouse, a trackball, a touchscreen, a touchpad, or cursor direction keys to communicate direction information and command selections to processor 710 and to control cursor movement on display 750. Camera and microphone arrays 790 of computer system 700 may be coupled to bus 705 to observe gestures, record audio and video and to receive and transmit visual and audio commands.

Computing system 700 may further include network interface(s) 780 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 780 may include, for example, a wireless network interface having antenna 785, which may represent one or more antenna(e). Network interface(s) 780 may also include, for example, a wired network interface to communicate with remote devices via network cable 787, which may be, for example, an Ethernet cable, a coaxial cable, a fiber optic cable, a serial cable, or a parallel cable.

Network interface(s) 780 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 780 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 780 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 700 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes a fashion profile platform including an analytics platform to receive consumer data from one or more consumer computing devices, generate a fashion profile for each of the one or more consumer devices based on the consumer data and provide analysis of the fashion profiles to one or more retail computing devices.

Example 2 includes the subject matter of Example 1, wherein the analytics platform provides consumer analytics to a consumer computing device based on a corresponding fashion profile.

Example 3 includes the subject matter of Examples 1 and 2, wherein the consumer analytics comprises an alert transmitted by the fashion profile platform to the consumer computing device indicating a product recommendation based on the fashion profile.

Example 4 includes the subject matter of Examples 1-3, wherein the fashion profile platform provides business analytics to each of the one or more retail computing devices.

Example 5 includes the subject matter of Examples 1-4, further comprising a brand portal to present business analytics to each of the one or more retail computing devices.

Example 6 includes the subject matter of Examples 1-5, wherein the brand portal comprises an analytics dashboard for each of the one or more retail computing devices to present the business analytics.

Example 7 includes the subject matter of Examples 1-6, further comprising an advertisement module to generate personalized advertising in accordance with a fashion profile and to transmit the personalized advertising to a consumer device associated with the fashion profile.

Example 8 includes the subject matter of Examples 1-7, wherein the analytics platform implements a hierarchical structure of data types to represent fashion profile data.

Example 9 includes the subject matter of Examples 1-8, wherein each data type comprises a name and one or more attributes.

Example 10 includes the subject matter of Examples 1-9, wherein the analytics platform creates an instance of a known data type.

Example 11 includes the subject matter of Examples 1-10, wherein the analytics platform defines custom data types.

Some embodiments pertain to Example 12 that includes a fashion profile generation method comprising receiving consumer data from one or more consumer computing devices, generating a fashion profile for each of the one or more consumer devices based on the consumer data and providing analysis of the fashion profiles to one or more retail computing devices.

Example 13 includes the subject matter of Example 12, further comprising providing consumer analytics to a consumer computing device based on a corresponding fashion profile.

Example 14 includes the subject matter of Examples 12 and 13, wherein the consumer analytics comprises an alert transmitted to the consumer computing device indicating a product recommendation based on the fashion profile.

Example 15 includes the subject matter of Examples 12-14, further comprising providing business analytics to each of the one or more retail computing devices via an analytics dashboard.

Example 16 includes the subject matter of Examples 12-15, further comprising generating personalized advertising in accordance with a fashion profile and transmitting the personalized advertising to a consumer device associated with the fashion profile.

Example 17 includes the subject matter of Examples 12-16, wherein the fashion profile data is represented by a hierarchical structure of data types.

Example 18 includes the subject matter of Examples 12-17, wherein each data type comprises a name and one or more attributes.

Some embodiments pertain to Example 19 that includes at least one computer readable medium having instructions stored thereon, which when executed by a processor, cause the processor to receive consumer data from one or more consumer computing devices, generate a fashion profile for each of the one or more consumer devices based on the consumer data and provide analysis of the fashion profiles to one or more retail computing devices.

Example 20 includes the subject matter of Example 19, having instructions stored thereon, which when executed by a processor, further cause the processor to provide consumer analytics to a consumer computing device based on a corresponding fashion profile.

Example 21 includes the subject matter of Examples 19 and 20, wherein the consumer analytics comprises an alert transmitted to the consumer computing device indicating a product recommendation based on the fashion profile.

Example 22 includes the subject matter of Examples 19-21, having instructions stored thereon, which when executed by a processor, cause the processor to provide business analytics to each of the one or more retail computing devices via an analytics dashboard.

Example 23 includes the subject matter of Examples 19-22, having instructions stored thereon, which when executed by a processor, cause the processor to generate personalized advertising in accordance with a fashion profile and transmit the personalized advertising to a consumer device associated with the fashion profile.

Example 24 includes the subject matter of Examples 19-23, wherein the fashion profile data is represented by a hierarchical structure of data types.

Example 25 includes the subject matter of Examples 19-24, wherein each data type comprises a name and one or more attributes.

Some embodiments pertain to Example 26 that includes a fashion profile generation apparatus comprising means for receiving consumer data from one or more consumer computing devices, means for generating a fashion profile for each of the one or more consumer devices based on the consumer data and means for providing analysis of the fashion profiles to one or more retail computing devices.

Example 27 includes the subject matter of Example 26, means for providing consumer analytics to a consumer computing device based on a corresponding fashion profile.

Example 28 includes the subject matter of Examples 26 and 27, wherein the consumer analytics comprises an alert transmitted to the consumer computing device indicating a product recommendation based on the fashion profile.

Example 29 includes the subject matter of Examples 26-28, further comprising means for providing business analytics to each of the one or more retail computing devices via an analytics dashboard.

Example 30 includes the subject matter of Examples 26-29, further comprising means for generating personalized advertising in accordance with a fashion profile and means for transmitting the personalized advertising to a consumer device associated with the fashion profile.

Example 31 includes the subject matter of Examples 26-30, wherein the fashion profile data is represented by a hierarchical structure of data types.

Some embodiments pertain to Example 32 that includes at least one computer readable medium having instructions stored thereon, which when executed by a processor, cause the processor to perform operations of method claims 12-18.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions in any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A fashion profile platform comprising an analytics platform to receive consumer data from one or more consumer computing devices, generate a fashion profile for each of the one or more consumer devices based on the consumer data and provide analysis of the fashion profiles to one or more retail computing devices.

2. The fashion profile platform of claim 1, wherein the analytics platform provides consumer analytics to a consumer computing device based on a corresponding fashion profile.

3. The fashion profile platform of claim 2, wherein the consumer analytics comprises an alert transmitted by the fashion profile platform to the consumer computing device indicating a product recommendation based on the fashion profile.

4. The fashion profile platform of claim 1, wherein the fashion profile platform provides business analytics to each of the one or more retail computing devices.

5. The fashion profile platform of claim 4, further comprising a brand portal to present business analytics to each of the one or more retail computing devices.

6. The fashion profile platform of claim 5, wherein the brand portal comprises an analytics dashboard for each of the one or more retail computing devices to present the business analytics.

7. The fashion profile platform of claim 1, further comprising an advertisement module to generate personalized advertising in accordance with a fashion profile and to transmit the personalized advertising to a consumer device associated with the fashion profile.

8. The fashion profile platform of claim 1, wherein the analytics platform implements a hierarchical structure of data types to represent fashion profile data.

9. The fashion profile platform of claim 8, wherein each data type comprises a name and one or more attributes.

10. The fashion profile platform of claim 8, wherein the analytics platform creates an instance of a known data type.

11. The fashion profile platform of claim 10, wherein the analytics platform defines custom data types.

12. A fashion profile generation method comprising:
receiving consumer data from one or more consumer computing devices;
generating a fashion profile for each of the one or more consumer devices based on the consumer data; and
providing analysis of the fashion profiles to one or more retail computing devices.

13. The method of claim 12, further comprising providing consumer analytics to a consumer computing device based on a corresponding fashion profile.

14. The method of claim 13, wherein the consumer analytics comprises an alert transmitted by the fashion profile platform to the consumer computing device indicating a product recommendation based on the fashion profile.

15. The method of claim 12, further comprising providing business analytics to each of the one or more retail computing devices via an analytics dashboard.

16. The method of claim 12, further comprising:
generating personalized advertising in accordance with a fashion profile; and
transmitting the personalized advertising to a consumer device associated with the fashion profile.

17. The method of claim 12, wherein the fashion profile data is represented by a hierarchical structure of data types.

18. The method of claim 17, wherein each data type comprises a name and one or more attributes.

19. At least one computer readable medium having instructions stored thereon, which when executed by a processor, cause the processor to:
receive consumer data from one or more consumer computing devices;
generate a fashion profile for each of the one or more consumer devices based on the consumer data; and
provide analysis of the fashion profiles to one or more retail computing devices.

20. The at least one computer readable medium of claim 19, having instructions stored thereon, which when executed by a processor, further cause the processor to provide consumer analytics to a consumer computing device based on a corresponding fashion profile.

21. The at least one computer readable medium of claim 20, wherein the consumer analytics comprises an alert transmitted by the fashion profile platform to the consumer computing device indicating a product recommendation based on the fashion profile.

22. The at least one computer readable medium of claim 19, having instructions stored thereon, which when executed by a processor, cause the processor to provide business analytics to each of the one or more retail computing devices via an analytics dashboard.

23. The at least one computer readable medium of claim 19, having instructions stored thereon, which when executed by a processor, cause the processor to:
generate personalized advertising in accordance with a fashion profile; and
transmit the personalized advertising to a consumer device associated with the fashion profile.

24. The at least one computer readable medium of claim 19, wherein the fashion profile data is represented by a hierarchical structure of data types.

25. The at least one computer readable medium of claim 24, wherein each data type comprises a name and one or more attributes.
